(19) United States
(12) Patent Application Publication
(10) Pub. No.: US 2015/0116530 A1
(43) Pub. Date: Apr. 30, 2015

(54) ARTICLE AUTHENTICATION APPARATUS HAVING A BUILT-IN LIGHT EMITTING DEVICE AND CAMERA

(71) Applicant: EASY PRINTING NETWORK LIMITED, Kwun Tong, Kowloon (HK)

(72) Inventors: Tak Wai Lau, Kwun Tong (HK); Wing Hong Lam, Kwun Tong (HK)

(73) Assignee: EASY PRINTING NETWORK LIMITED, Kwun Tong, Kowloon (HK)

(21) Appl. No.: 14/404,564

(22) PCT Filed: May 30, 2013
(86) PCT No.: PCT/IB2013/054463

§ 371 Date: Nov. 28, 2014

(30) Foreign Application Priority Data
May 30, 2012 (HK) 12105265.3
Aug. 10, 2012 (HK) 12107864.4
Jan. 21, 2013 (HK) 13100895.1

(51) Int. Cl. G06K 9/62

(52) U.S. Cl. CPC G06K 9/6201
USPC 348/222.1

(57) ABSTRACT

An apparatus (100, 1001) comprises an image capturing device (110), a light emitting device (112) for illuminating an object to be captured by the image capturing device (110), a visual guide (114) to guide a user to aim the apparatus (100, 1001) at a target authentication device (140), and a processor (102). The visual guide (114) is devised such that when the apparatus (100, is aimed at the target authentication device (140) following guidance of the visual guide (114), the brightness levels on an image of the target authentication device (140) captured by the image capturing device (110) while under illumination of the light emit ting device (112) are within a predetermined range of brightness levels to facilitate verification of authenticity with reference to the captured image of the target authentication device (140).

### FIELD

The present disclosure relates to authentication apparatus and methods, and more particularly to authentication apparatus and methods for verifying authenticity of a target authentication device by taking an image thereof.

### BACKGROUND

Counterfeiting is a serious problem which not only disrupts normal commercial or non-commercial activities but also poses safety as well as security issues to the general public. Many types of anti-counterfeiting measures are dedicated to help fight counterfeiting. For example, genuine goods carry authentication devices such as authentication tags or codes to help verify authenticity of goods or products. However, even such authentication tags or codes can become the subject of rampant counterfeiting and enhanced security measures to combat counterfeiting are desirable.

High precision authentication devices such as those comprising digitally coded security patterns are very useful in combating counterfeiting because digitally coded information subsisting in the security patterns are very sensitive and are difficult to counterfeit. The moiré pattern is a good example of authentication devices comprising digitally coded security patterns which has been widely used to enhance reliability of authentication devices. The term ‘authentication device’ in the present context generally means authentication device for use in combating counterfeiting.

While authentication devices comprising digitally coded security patterns such as moiré or moiré-type patterns are very useful in the combat of counterfeits, the highly precise and delicate nature of the security patterns mean that a high fidelity reproduction of the security patterns is often needed to facilitate reliable authentication.

Many modern mobile electronic devices such as mobile phones, smart phones, tablet computers, or notebook computers have built-in digital cameras and should be useful for taking an image of an authentication device for verification of authenticity. However, trials show that the quality of images of authentication devices taken by such mobile electronic devices is not satisfactory enough to facilitate authentication applications.

It would be advantageous if an improved authentication apparatus and/or improved image capturing method are provided such that a high fidelity image of an authentication device can be obtained.

### DESCRIPTION OF THE FIGURES

The disclosure will be described by way of non-limiting example with reference to the accompanying Figures, in which:

FIG. 1 is functional block diagram of an example apparatus suitable for operation as an authentication apparatus according to the present disclosure,

FIG. 1A is a first view of an example authentication apparatus having the functional block diagram of FIG. 1

FIG. 1B is a second view of the example authentication apparatus of FIG. 1 A,

FIG. 2A and 2B depict an example operation using the authentication apparatus of FIG. 1A to take an image of an example authentication device respectively at a first location and a second location,

FIG. 3A and 3B depict schematic representations of an image of the example authentication device appearing on the display of the example authentication apparatus of FIG. 1A corresponding to capturing at the locations of FIGS. 2A and 2B respectively ,

FIG. 4 is a schematic representation depicting an example distribution of pixel brightness levels of a first captured image of the example authentication device taken by the example authentication apparatus at the relative position as depicted in FIGS. 2A and 3A,

FIG. 4A depicts a copy of the first example captured image of the example authentication device,

FIG. 4B depicts an example decision flow to determine acceptability of the first captured image,

FIG. 5 is a schematic representation depicting an example distribution of pixel brightness levels of a second captured image of the example authentication device taken by the example authentication apparatus at the relative position as depicted in FIGS. 2B and 3B,

FIG. 5A depicts a copy of the example second captured image of the example authentication device,

FIG. 5B depicts an example decision flow to determine acceptability of the second captured image,

FIG. 6 depicts an example flow chart to devise a visual guide with reference to an upper threshold brightness level,

FIG. 7 depicts an example flow chart to devise a visual guide with reference to a lower threshold brightness level,

FIG. 8 is an example flowchart depicting execution of an example authentication process on an example authentication apparatus, and

FIGS. 9, 9A, and 9B are screen views depicting example operation of the authentication process of FIG. 8 on the example authentication apparatus of FIG. 1A.

### DESCRIPTION

There is disclosed an authentication image capturing method for use with an apparatus comprising an image capturing device, a light emitting device to project light for illuminating an object to be captured by the image capturing device, and a processor. The authentication image capturing method may be part of an authentication method for verifying authenticity of a target authentication device containing security features such as digitally coded security features. Therefore, the authentication image capturing method is also an authentication method.

The authentication method includes devising a visual guide for guiding a user to aim the apparatus at a target authentication device on execution of an authentication process such that when the apparatus is aimed at the target authentication device following guidance of the visual guide to capture an image of the target authentication device, the content and quality of fidelity of the captured image is sufficient to facilitate verification of authenticity of the target authentication device.

The visual guide may be devised such that when the apparatus is aimed at the target authentication device so that an alignment device on the visual guide is aligned with a corresponding alignment device on the target authentication device, an image of the target authentication device thus captured will result in an image having a sufficient content to facilitate verification of authentication. A sufficient content in the present context means that the quantity of image data of the target authentication device is sufficient to make decision on authenticity of the target authentication device. The dimension and shape of the visual guide is designed to capture a sufficient content.

The visual guide may be devised such that when the apparatus is aimed at the target authentication device so that the alignment device on the visual guide is aligned with the corresponding alignment device on the target authentication device, an image of the target authentication device thus captured will result in an image having a sufficient quality of fidelity to facilitate verification of authentication. A sufficient quality of fidelity in the present context means the captured image of the target authentication device contains a collection of image data which is a sufficiently true, accurate or correct representation of the target authentication device to facilitate making of determination on the authenticity of the target authentication device.

The visual guide may be devised empirically using a reference apparatus and a reference sample of the target authentication device (the ‘reference authentication device’). For example, the visual guide may be devised by taking sample images of the reference authentication device at different relative locations between the image capturing device and the reference authentication device which meets the content requirement while under illumination of the light emitting device and to select a relative location which generates a correct authentication result as the visual guide. A correct authentication result would mean that the requirement on the quality of fidelity on the image data is satisfied. It will be appreciated that the relative locations will be represented by images shown on different portion of the display of the reference apparatus without loss of generality. Where there is more than one location which gives a correct authentication result, the relative location that gives an image that best satisfies predetermined brightness thresholds is selected to set the visual guide. For example, the relative location maybe one corresponding to where the sample image has a more even distribution of pixel intensity will be selected as the location to set the visual guide. In an example, where there is more than one location which gives a correct authentication result, the relative location which is furthest away from locations where the quality of image data fidelity is not satisfied is selected as the relative location to set the visual guide,

The visual guide may be devised using image processing techniques. For example, a sample authentication device having the same digitally coded features arranged in the same manner as the target authentication device but extend over the entire image capturing region of the image capturing device may be used as a calibration sample to calibrate the reference apparatus to set the visual guide. As the same digitally coded features are arranged in the same manner as the target authentication device, the same light reflection and distortion properties can be expected. An extended image of the sample authentication device which is taken by having the sample authentication device covering the entire image capturing region of the image capturing device while under illumination of the light emitting device and meeting the content requirement would mean that calibration can be done with respect to a single extended image of the sample authentication device.

The reference authentication device or the sample authentication device may be used as a calibration sample to set a visual guide meeting the fidelity requirements.

In calibration operation, an operator will aim the apparatus at the calibration sample and capture an image of the calibration sample while under operational illumination of the light emitting device. The digital data embedded in the captured image of the calibration sample are then recovered and analysed by the processor or manually to examine the quality of fidelity of the digitally data embedded in the captured image. The visual guide will be set at a region where the quality of fidelity satisfies a predetermined fidelity threshold. Where the region can accommodate more than one visual guide, the visual guide may be selectively set at a region where the brightness levels of pixels associated with the captured sample image can best satisfy predetermined brightness thresholds. In the description herein, the terms ‘fidelity’, ‘truthfulness’, ‘correctness’, ‘accuracy’ and the respective adjectives will be interchangeably used when the context so permits or requires.

In an example, the method includes devising the visual guide such that brightness levels on an image of the calibration sample which was captured by the image capturing device while under operational illumination of the light emitting device are within a predetermined range of brightness levels suitable for verification of authenticity. The range of predetermined threshold brightness levels may be selected to be a range within which the quality of the captured image of the calibration sample is sufficient to facilitate verification of authenticity. The resolution of a captured image is an aspect of quality which relates to factors affecting verification of authenticity.

The predetermined range of brightness levels may include an upper brightness threshold level and/or a lower brightness threshold level. The upper brightness threshold level may be set at a level above which there is a good likelihood that the image has been distorted by over-illumination. For example, the upper threshold brightness level may be set near the maximum intensity level available to the pixels. The maximum intensity corresponds to brightness saturation such that further increase in brightness at the calibration sample will not increase the intensity level at the pixels. The lower brightness threshold level may be set at a level below which there is a good likelihood that the image has been distorted by under-illumination. For example, the lower threshold brightness level may be set near the minimum intensity level available to the pixels. The minimum intensity corresponds to darkness saturation such that further increase in darkness at the calibration sample will not increase the darkness level at the pixels.

The display may be a built-in display of the reference apparatus or an external display. For example, the reference apparatus may have a video output or a projector output to cause display of the image on the external display.

In an example, the method includes identifying a display portion of a display associated with the reference apparatus, the display portion being such that an image of the calibration sample corresponding to an image appearing on that display portion when captured such that the brightness levels on the captured image are within the predetermined range of brightness levels will provide sufficient data to facilitate verification of authentication. The method includes aiming the reference apparatus at calibration sample such that an image of the calibration sample will appear on a portion of a display, capturing an image of the calibration sample while under illumination of the light emitting device, analyzing brightness levels on the captured image, devising the visual guide on that display portion when the brightness levels on the captured image are within the predetermined range of brightness levels.

In an example, the method includes selecting a display portion having a more optimal distribution of brightness levels on the captured image for authentication verification as the visual guide when there are more than one display portions satisfying requirements.

In an example, the method includes selecting a display portion that is outside an axis of light projection which corresponds to a line of the brightest illumination by the light emitting device on the sample target authentication device to devise the visual guide.

In an example, the method is in the form of a downloadable software application for running on an apparatus comprising a processor, and the downloadable application is apparatus specific such that the application is to be downloaded for a specific apparatus with reference to the model number of the apparatus to run the authentication method. The apparatus may be a staple microprocessor based device such as a smart phone, a tablet computer or a digital camera.

The method may be implemented in hardware, software, firmware or a combination thereof. In an example, the method is implemented on a smart phone such that the smart phone operates as an authentication apparatus running the authentication image capturing method upon actuation by a user.

Therefore, an authentication apparatus for verifying authenticity of a target authentication device is disclosed. The authentication apparatus comprises an image capturing device, a light emitting device for illuminating an object to be captured by the image capturing device, a visual guide to guide a user to aim the apparatus at a target authentication device, and a processor. The visual guide is such that when the apparatus aims at a target authentication device following guidance of the visual guide on execution of an authentication process, the content and quality of fidelity of an image of the target authentication device captured by the image capturing device under operational illumination of the light emitting device are sufficient to facilitate verification of authenticity of the target authentication device.

In an example, the visual guide is such that when the apparatus is aimed at the target authentication device following guidance of the visual guide, the brightness levels on an image of the target authentication device captured by the image capturing device while under operational illumination of the light emitting device are within a predetermined range of brightness levels to facilitate verification of authenticity with reference to the captured image of the target authentication device.

In an example, the processor is to process the captured image to generate a visible representation of security features embedded in the target authentication device for a user to verify authenticity of the target authentication device.

In an example, the visual guide includes an alignment device for aligning with a corresponding alignment device on the target authentication device. The visual guide and the light emitting device may be arranged such that an axis of light projection corresponding to a line of the brightest illumination by the light emitting device falls outside security features of the target authentication device when the apparatus is aimed at the target authentication device following guidance of the visual guide such that the alignment device of the visual guide and the corresponding alignment device on the target authentication device are aligned.

In an example, the apparatus includes an associated display device and the processor is to generate the visual guide on the associated display device.

The apparatus may include a projector and the processor is to generate the visual guide for projection by the projector.

The target authentication device may comprise an embedded security device having hidden security features, such as digitally coded security features, and the processor is to process the captured image of the target authentication device to extract the security features for display.

Example of authentication methods and authentication apparatus will be described in more details below with reference to the accompanying Figures.

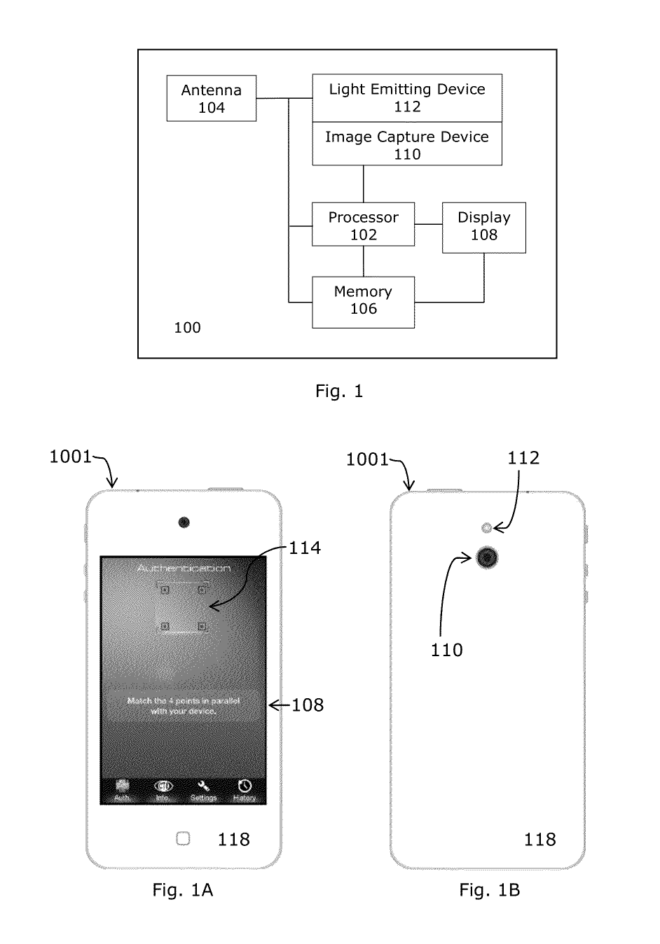

The functional block diagram of FIG. 1 depicts an example apparatus 100 which is capable of operating as an authentication apparatus and comprises a processor 102, an antenna 104, a memory 106, a display 108, an image capturing device 110, a light emitting device 112 and a visual guide 114. A smart phone is an example of such an apparatus. The display screen is to facilitate visual interface with a user and usually comprises a matrix of liquid crystal cells which collectively form an LCD display. An LCD display of many electronic devices having more than 1 million pixels is common place nowadays. For example, a typical LCD display of smart phones have the pixel size of 320×480 pixels, 640×960 pixels, or 640×1136 pixels distributed in a 10-cm diagonal screen. The image capturing device comprises an image collector which is optically coupled to an image sensor. The image collector may be a lens, an assembly of lens or a pin-hole device. The image sensor includes a matrix of image sensing elements such as an array of charge coupled devices (CCD). The number of image sensing elements is approximately at a 1:1 correspondence with the pixel size of the display screen but the actual number of images sensing elements can be different depending on the application and design. Each image sensing element forms a pixel of an image collected by the image capturing device and each of the image sensing elements is deployed to detect the brightness level of light imparting on it. A digital image is formed when the entirety of data representing the brightness levels of individual pixels is collected by the processor in spatial order and stored.

The light emitting device is to provide supplemental illumination on an object when an image of the object is to be taken by the image capturing device under an ambient condition when the ambient light level is insufficient. Supplemental illumination is often required when the ambient illumination is below a level which is needed for the image capturing device to produce an image of sufficient quality of fidelity to facilitate verification of authenticity. The light emitting device of this example comprises LED lamps which are arranged to emit a beam of light along an axis of light projection towards a target object. The axis of light projection is characteristic of the light emitting device and defines a direction of brightest illumination such that the portion of the object intercepting or encountering the axis of light projection will experience the brightest supplemental illumination.

The visual guide is to provide visible guidance to assist a user to aim the authentication apparatus at a target authentication device so that when the authentication apparatus is aimed at the target authentication device following the guidance of the visual guide, an image of the target authentication captured by the image capturing device of the authentication apparatus will contain a sufficient quantity of necessary authentication data and have a sufficient quality of fidelity to facilitate verification of authenticity.

So that a captured image of the target authentication device contains sufficient quantity of data to facilitate verification of authenticity, the visual guide defines an image alignment device such as an image alignment window such that when the apparatus is aimed at the target authentication device with the image alignment device on the target authentication device aligned with a corresponding image alignment device on the visual guide, the captured image will have a sufficient quantity of necessary authentication data to facilitate verification. In general, the data image will be sufficient in quantity if the captured image has captured the portion of the target authentication device containing all the security data which are embedded in the target authentication device. In many modern day applications, the security data are digitally encoded in the target authentication device.

So that a captured image of the target authentication device have a sufficient quality of fidelity to facilitate verification of authenticity, the visual guide defines an illumination alignment device such as an illumination alignment window such that when the apparatus is aimed at the target authentication device with the illumination alignment device on the target authentication device aligned with a corresponding an illumination alignment device on the visual guide, the supplement illumination falling on the authentication device or at least the portion of the authentication device to be authenticated will result in an image at the image capturing device such that the brightness levels of the pixels are within a prescribed range of brightness levels which is to facilitate verification of authenticity. Specifically, the prescribed range of brightness levels is a range within which the brightness levels of all the pixels of the captured image are neither over-exposed nor under-exposed. An image or a portion of an image is over-exposed when taken under over-illumination of the light emitting device such that the brightness level of the pixel reaches the saturation intensity. An image or a portion of an image is under-exposed when taken with insufficient or under illumination. Over-exposure and under-exposure are undesirable in authentication applications since an over-exposed or an under-exposed image means distortion and/or loss of important details during the image capturing process.

The processor is to set the visual guide on the display to provide guidance or assistance to a user to capture an image of a target authentication device having a sufficient data quantity and a sufficient quality of fidelity. In an example, the processor is to set the illumination alignment device and the image alignment device on the display screen upon activation of an authentication process. In an example, the illumination alignment device and the image alignment device are combined as a single visual alignment device and the processor is to set the visual alignment device to be shown on a portion of the display to guide user. The processor is to operate the image capturing device and the light emitting device to capture an image of the authentication device when confirmed by a user that an image of the target authentication device appearing on the display screen is aligned with the visual alignment device. In an example, an authentication verification process may be resident on the apparatus to perform verification of authenticity of a target authentication device with reference to a set of pre-stored parameters such as an image of a reference authentication device stored on the apparatus. In another example, the authentication process may output the captured image of a target authentication device for external or remote verification.

The memory is for storing an authentication operation process, such as an authentication image capturing scheme and/or an authentication verification scheme for execution by the processor. The antenna is optional and is present when the apparatus is equipped with telecommunications functionality, such as a mobile phone.

Operation of an example authentication apparatus comprising a smart phone depicted in FIGS. 1A and 1B which is installed with an authentication process to operate as an authentication apparatus will be described. An iPhone™ such as an iPhone™, iPhone 4™ iPhone 4S™, iPhone 5™ of the Apple Inc., or a Galaxy™ smart phone of Samsung inc., are examples of smart phones that can be used.

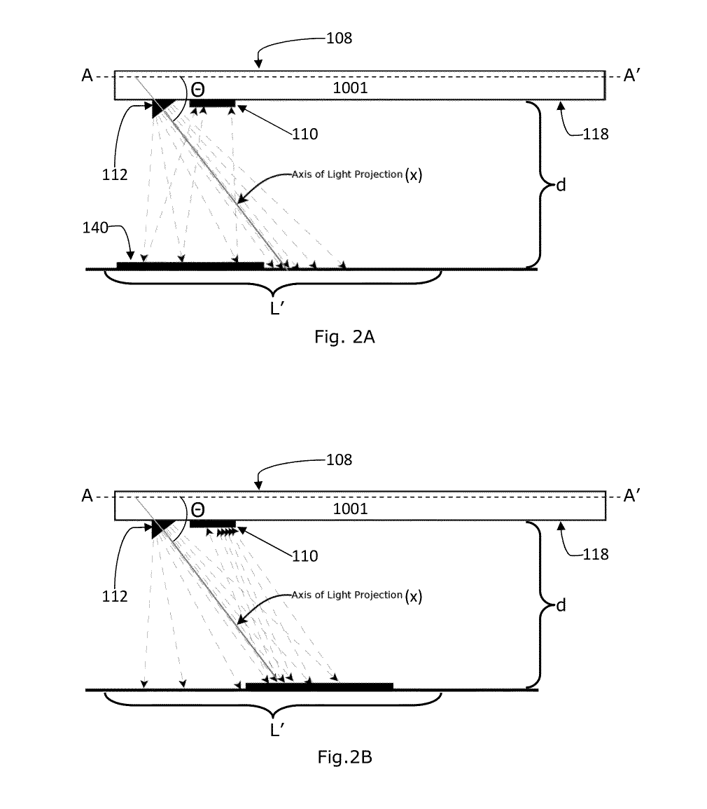

The example authentication apparatus 1001 of FIGS. 1A and 1B comprises a processor 102, an antenna 104, a memory 106, a display screen 108, an image capturing device 110, a light emitting device 112 and a visual guide 114 of the type described above. An authentication process is stored in the memory of the authentication apparatus. The authentication apparatus 1001 includes a rigid and elongate housing 118 of hard plastics which extends along a longitudinal direction that is parallel to a longitudinal axis A-A′ as depicted in FIGS. 2A and 2B. The image capturing device 110 and the light emitting device 112 are on different major sides of the housing 118. Specifically, the image capturing device 110 and the light emitting device 112 are on the back side of the housing 118 while the display screen 108 is on the front side of the housing 118. When an image of an object is captured during authentication operation, the housing 118 is between the object and its image on display.

The light emitting device 112 is arranged to project light towards a longitudinal end of the housing which is distal from the light emitting device 112. As depicted in FIGS. 2A and 2B, the axis of light projection X of light emitting device 112 is at an acute angle A to the longitudinal axis A-A′. The image capturing device 110 and the display screen 108 are such that when an object having a planar surface of length L′ is placed with its planar surface parallel to and at a distance d from the longitudinal axis A-A′, a corresponding image of the object will just occupy the entire length L of the display screen 108, and the image on display is geometrically proportional or substantially proportional to the planar surface.

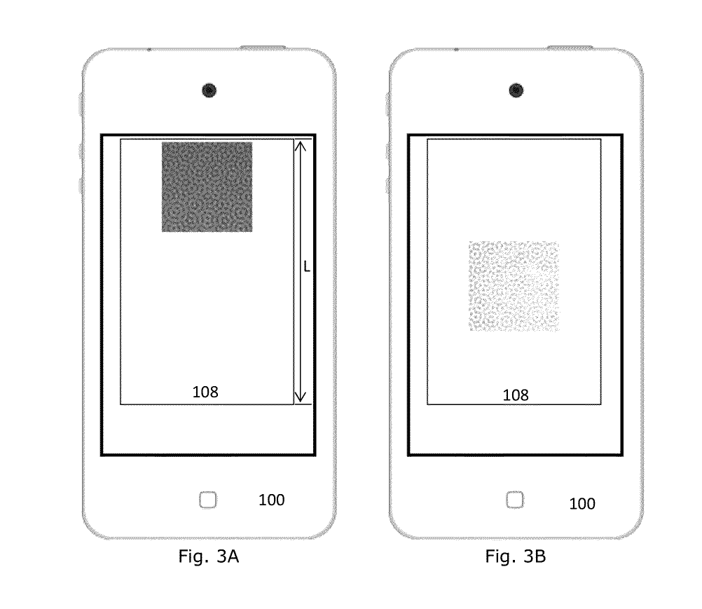

In this example, the visual guide 114 is devised such that when the visual alignment device of the visual guide appearing on the display screen is shown to be in alignment with a corresponding alignment means on the target authentication device 140, the target authentication device 140 to be authenticated will be at the location as depicted in FIG. 2A relative to apparatus, the planar surface to be authenticated will be at a distance d from the axis A-A′, and the image will appear on the portion of the display screen as shown in FIG. 3A. On the other hand, when the relative position between the target authentication device 140 and the apparatus 1001 is changed such that the target authentication device 140 is relatively closer to the distal longitudinal end of the apparatus while maintaining an image of the same or similar size as depicted in FIG. 2B, the image will appear on the portion of the display screen which is closer to the distal longitudinal end as shown in FIG. 3B.

When the authentication process is activated by a user, for example, by activating a touch-screen icon, the authentication process will be activated and the visual guide 114 will be displayed on the display screen 108 as depicted in FIG. 1A to inform a user that the apparatus is now ready and available to operate as an authentication apparatus to verify the authenticity of a target authentication device 140.

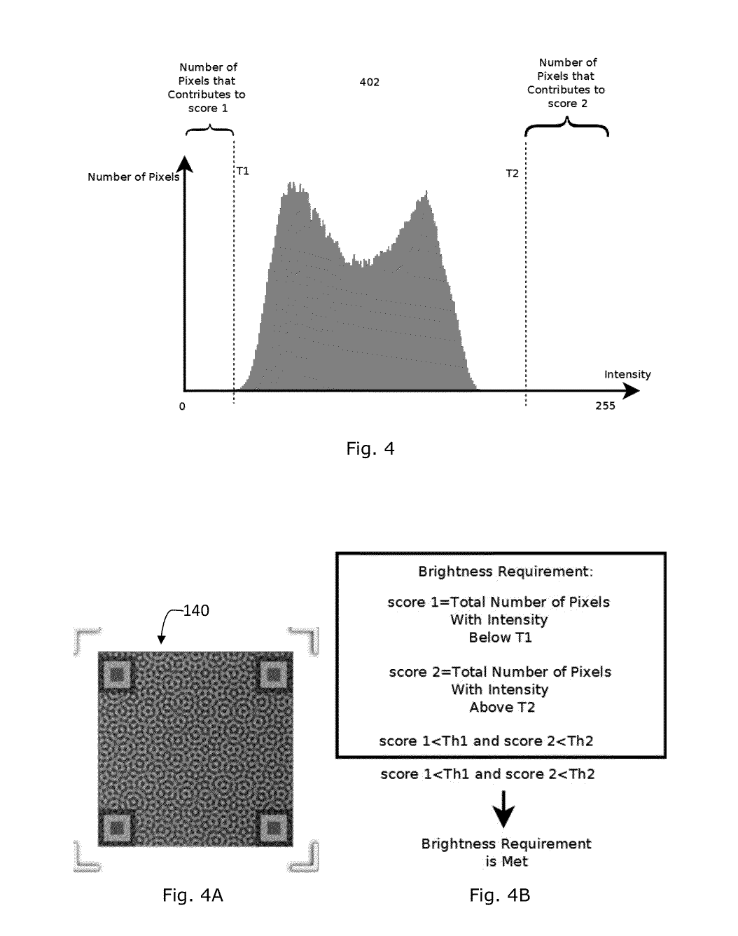

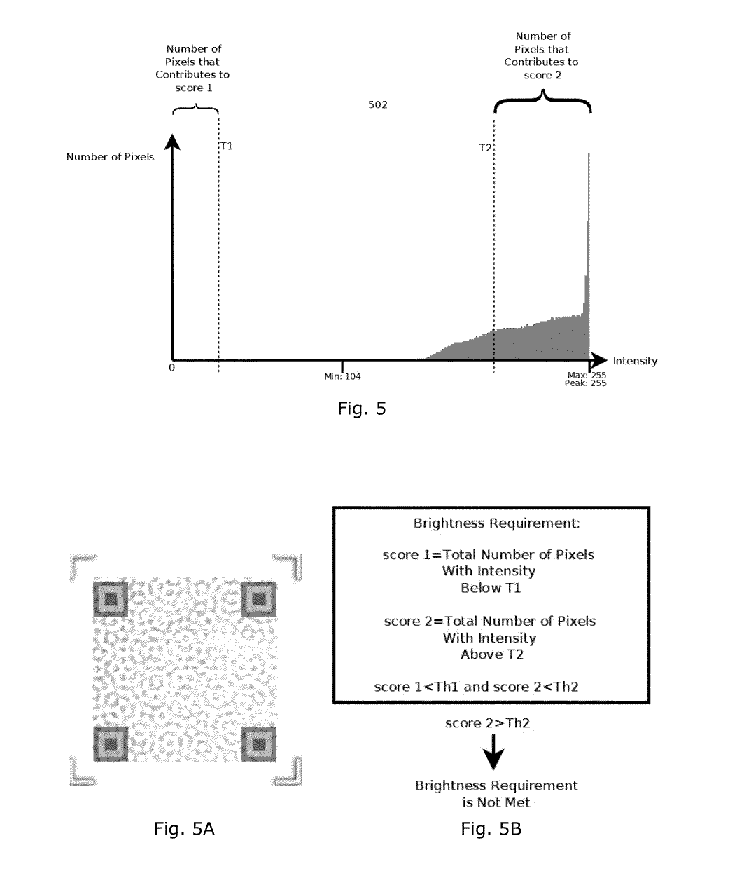

Upon activation, the processor will generate an alignment device which is to appear on a portion of the display screen to guide a user to aim the apparatus at a target authentication device as depicted in FIG. 1A. A user will activate the authentication apparatus to capture an image of the authentication device for authentication applications when the alignment device on the display screen is aligned with an alignment device on the target authentication device. The image captured by this process is shown in FIG. 4A and has an acceptable brightness level distribution as depicted in FIG. 4 according to the criterion of FIG. 4B.

Where an image is captured with the target authentication device out of a region defined by the visual alignment device while maintaining the same image size (or content) on the display screen, an image having a different pixel brightness distribution to that of FIG. 4 will result. For example, when the target authentication device is shifted towards the axis of light projection X of the light emitting device while maintaining the same image size of the target authentication device, an over-exposed image as shown in FIG. 5A having a pixel brightness distribution as depicted in FIG. 5 which is not acceptable according to the criterion of FIG. 5B will result. The over-exposed image is resulted since a substantial portion of the target authentication device intercepts with the axis of light projection of the light emitting device.

An example calibration scheme to calibrate a reference authentication apparatus to devise a visual guide will be described below. The calibration result will be applied for use on other authentication apparatus having the same or compatible image capturing specifications. Apparatus of the same image capturing specifications in the present context means that the apparatus have the same or equivalent light emitting device and the same or equivalent image capturing device arranged in the same inter-relationship.

In order to facilitate capturing of an image of the reference authentication device having sufficient image data to facilitate authentication of other target authentication devices, a visual alignment device as an example of a visual guide depicted in FIG. 1A is set on the display of the reference authentication apparatus for user guidance. The visual alignment device is devised to assist a user to collect an image having a sufficient quantity of image data from a target authentication device to facilitate verification of authentication and comprises alignment means. The example alignment means comprises alignment markers which are distributed at corners of the visual alignment device. The alignment markers are arranged such that when the alignment markers are visually aligned with corresponding alignment markers on the reference authentication device, the image to be collected will contain a sufficient quantity of image data to facilitate verification of authenticity.

The example reference target authentication device of FIG. 4A has an overall dimension of 15 mm×15 mm (width×length) of which only a 9 mm×9 mm portion at the centre defines the digitally coded security features. This 9 mm×9 mm portion can be fully and accurately represented by digital coding of 100 pixels×100 pixels. This quantity of pixel provides a sufficient quantity of image data to facilitate meaningful authentication applications with reference to an image of a sufficient resolution level. Therefore, the visual alignment device is devised to capture 300 pixels×300 pixels as an example. When the visual alignment device is shown on the display as being aligned with a corresponding alignment device on the example reference authentication device, the entire 15 mm×15 mm of the reference authentication device will be captured and stored as 300 pixels×300 pixels available for verification, although only the 100 pixels×100 pixels corresponding to the central portion of the captured image contain the critical data needed for authentication.

In addition to having a sufficient quantity of image data, the fidelity of the captured image data is also important so that a meaningful authentication can be performed with respect to the captured image. In order that the captured image truly represents the target authentication device, the image alignment device is moved to different locations on the display to correspond to different illumination conditions by the light emitting device. It is noted that when the brightness level of the captured image of the reference target authentication device are distributed between the upper and lower brightness thresholds, the fidelity of the image is acceptable for authentication. On the other hand, when the brightness level of the captured image of the reference target authentication device falls outside the upper brightness threshold or the lower brightness threshold, the fidelity of the image is not acceptable for authentication.

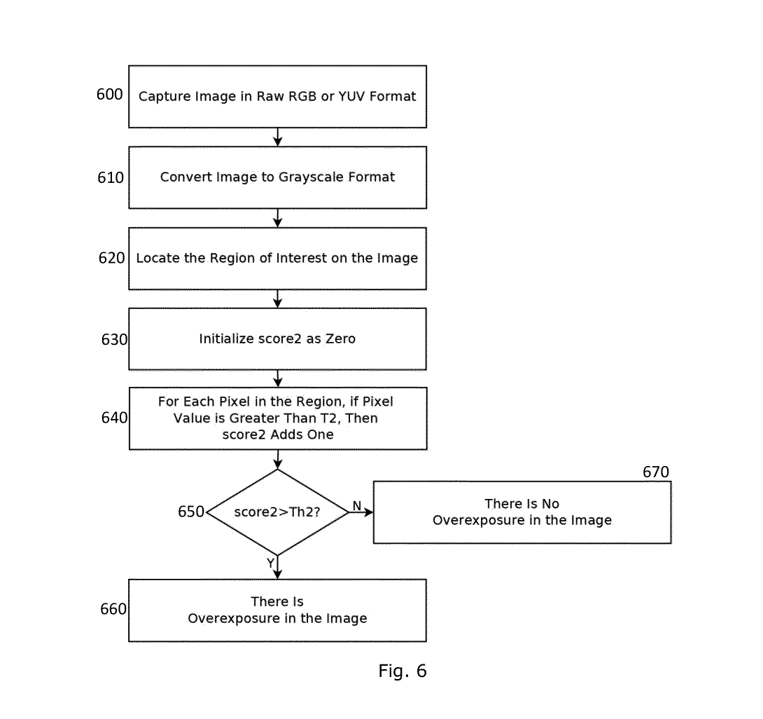

FIG. 6 depicts an example flow chart to determine whether a captured image satisfied the pixel brightness requirements with respect to the upper brightness threshold T2. At step 600, an image of the reference target authentication device is captured in raw RGB or YUV format. At step 610, the image data is converted into pixel data in greyscale (or grayscale) format. At step 620, the greyscale data corresponding to a region of the captured image which is of importance to facilitate authenticity verification is selected to analyze whether the requirements on the upper brightness threshold T2 are met. At step 630, a score (score2) representing the number of pixels having a brightness or intensity exceeding the upper brightness threshold T2 is initialized to zero. At step 640, the number of pixels having a brightness or intensity exceeding the upper brightness threshold T2 is counted. The total number of pixels having a brightness or intensity exceeding the upper brightness threshold T2 is calculated and a decision is to be made at step 650. If the total number of pixels having a brightness or intensity level exceeding the upper brightness threshold T2 is above a threshold count Th2, there is an over-exposure problem with the captured image and the image (and hence the location of the reference target authentication device relative to the apparatus) is not acceptable as the quality of fidelity would not be acceptable to perform a meaningful authentication verification process. On the other hand, if the total number of pixels having a brightness or intensity level exceeding the upper brightness threshold T2 does not exceed the threshold count Th2, there is no over-exposure problem with the captured image and the image (and hence the location of the reference target authentication device relative to the apparatus) is acceptable as the quality of fidelity would be acceptable to perform a meaningful authentication verification process.

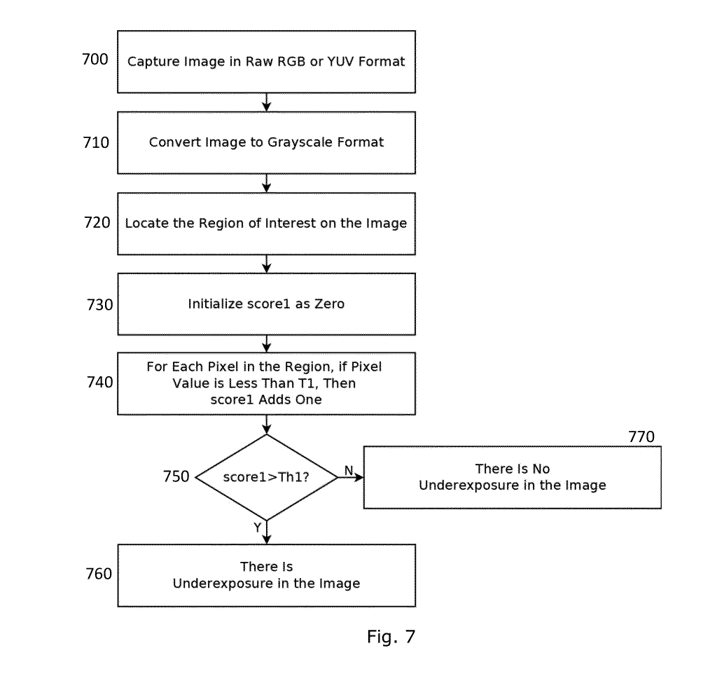

FIG. 7 depicts an example flow chart to determine whether a captured image satisfied the pixel brightness requirements with respect to the lower brightness threshold T1. At step 700, an image of the reference target authentication device is captured in raw RGB or YUV format. At step 710, the image data are converted into pixel data in greyscale (or grayscale) format. At step 720, the greyscale data corresponding to a region of the captured image which is of importance to facilitate authenticity verification are selected to analyze whether the requirements on the lower brightness threshold T1 are met. At step 730, a score (score2) representing the number of pixels having a brightness or intensity falling below the lower brightness threshold T1 is initialized to zero. At step 740, the number of pixels having a brightness or intensity below the lower brightness threshold T1 is counted. The total number of pixels having a brightness or intensity below the lower brightness threshold T1 is calculated and a decision is to be made at step 750. If the total number of pixels having a brightness or intensity level below the lower brightness threshold T1 is above a threshold count Th1, there is an under-exposure problem with the captured image and the image (and hence the location of the reference target authentication device relative to the apparatus) is not acceptable as the quality of fidelity would not be acceptable to perform a meaningful authentication verification process. On the other hand, if the total number of pixels having a brightness or intensity level below the lower brightness threshold T1 does not exceed the threshold count Th1, there is no under-exposure problem with the captured image and the image (and hence the location of the reference target authentication device relative to the apparatus) is acceptable as the quality of fidelity would be acceptable to perform a meaningful authentication verification process.

For example, an image of the reference authentication device as shown in FIG. 5A was taken with the visual guide corresponding to the reference authentication device at the location shown in FIG. 3B. The image is very pale or whitened because it contains image data which are above an upper brightness threshold T2 and the data fidelity is not acceptable. On the other hand, the image of the reference authentication device as shown in FIG. 4A was taken with the visual guide corresponding to the reference authentication device at the location shown in FIG. 3A. This image has all the image data within a brightness range which is a range between a lower threshold brightness level T1 and an upper brightness threshold T2. All the data within this brightness range has a data fidelity which is acceptable for authentication applications.

After evaluating several images of the reference authentication device, the location of a visual alignment device corresponding to a captured image meeting the aforesaid brightness range requirements will be selected and set as the visual alignment device of the reference authentication apparatus to complete calibration.

In an example, instead of evaluating the distribution of pixel brightness levels on a captured image, the data fidelity of the captured image can be evaluated by decoding the captured image to recover the digital coding embedded in the captured image and comparing the data with that of the reference target authentication device. A visual guide which generates an image having an acceptable data fidelity level will then be selected and set as the visual alignment device of the authentication device to complete calibration.

In another example, an extended sample authentication device having the same content as that of the reference authentication device of FIG. 4A but extended to cover the entire range of the image capturing device may be used to calibrate and set a visual guide. An image of the extended sample authentication device is captured and the data fidelity of the digitally coded data is examined to select a region having acceptable data fidelity to be set as a location of the visual guide to complete calibration.

After calibration has completed and the visual guide devised, the visual guide can be included as part of an authentication process for guiding a user to capture an image of a target authentication device for verification of authenticity. The verification can be done internally by the apparatus or externally by another authentication apparatus without loss of generality.

In an example, the calibration data are used to devise a visual guide on an authentication apparatus, such as an authentication apparatus of FIG. 1A, upon execution of an authentication process. The authentication process may be made available as an application software for a smart phone for which calibration has been done to set a visual guide such that upon installation and activation, the smart phone or compatible apparatus will operate as an authentication apparatus.

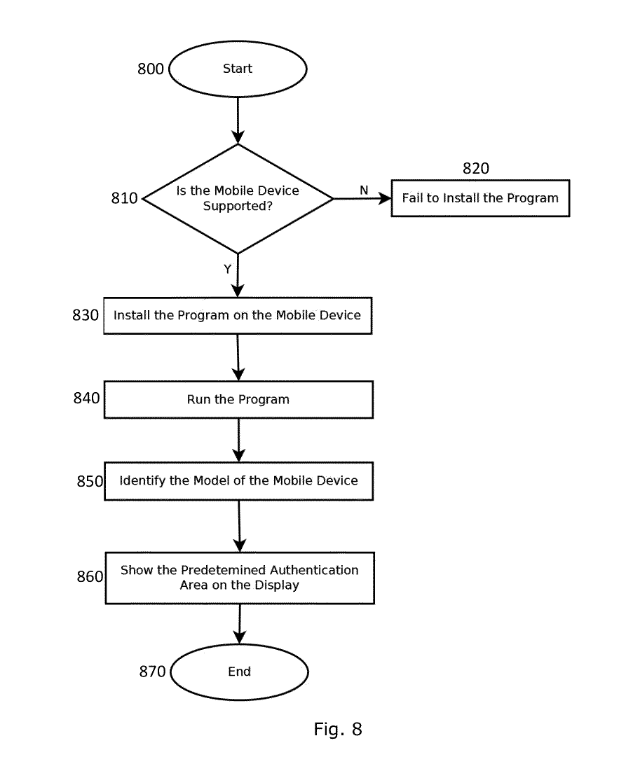

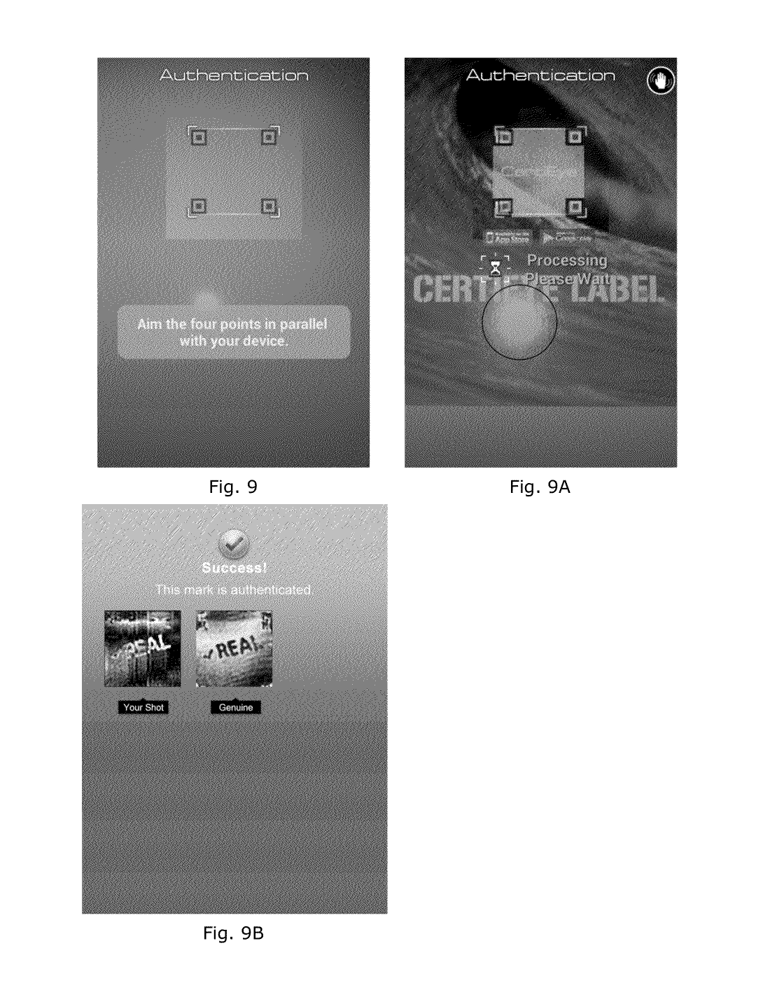

As depicted in FIG. 8, a user may access the Internet to look for an authentication application software designated for a specific model of smart phone. If there is an application software available for the specific smart phone, the application software will be downloaded and installed on the smart phone. Upon execution of the application software for authentication of a target authentication device, the model identification of the smart phone will be confirmed and the visual guide will appear on the display to run the authentication process as depicted in FIGS. 9 to 9B.

When the visual guide appears on the display, a text message on the display will guide the user to align the visual guide with a corresponding alignment device on the target authentication device. A user will then aim the authentication apparatus so that the image capturing device is ready to capture an image of the target authentication device shown on the display. The processor will then operate the image capturing device to capture and store an image of the target authentication device upon receipt of a confirmation signal given by the user. The apparatus can then perform verification using an internal or built-in verification algorithm or make the captured image available for external verification.

FIG. 8 depicts an example flow chart illustrating steps whereby a mobile phone is to operate as an authentication apparatus upon execution of an authentication process. The process starts at step 800 when a user looks for an authentication process in the form of application software that is adapted for use for a specific type of device. A decision will be made at step 810. If there is no applicable software application, the process at step 820 will terminate and the mobile device cannot operate as an authentication apparatus for in respect of a target authentication device. On the other hand, if there is an applicable software application available, the process at step 830 will obtain the software and install on the mobile device. At step 840, the mobile device after having installed the application software will execute the software and run the authentication process defined by the application software. Where the software application is suitable for more than one mobile device, the process at step 850 will identify the model of the mobile device. On execution of the authentication process at step 860, the processor will devise a visual guide on the display to guide a user to operate the authentication apparatus and an image of a target authentication device will be captured by the authentication apparatus upon receipt of instructions given by a user. The visual guide may also include text messages as shown in FIGS. 9 to 9B. The process ends at step 870 after an image of the target authentication device has been captured and corresponding verification process completed.

While the authentication methods and apparatus have been described with reference to the above examples and embodiments, it should be appreciated that the examples and embodiments are only to assist understanding and shall not be used to limit the scope of disclosure. For example, while the example authentication processes have been illustrated with reference to operation on a smart phone, it should be appreciated that other portable or mobile electronic devices such as tablet computers or dedicated verification apparatus can be used without loss of generality. As another example, the display may be built-in on the authentication apparatus or can be an external display.

1. An authentication apparatus for verifying authenticity of a target authentication device, the apparatus comprising an image capturing device, a light emitting device for illuminating an object to be captured by the image capturing device, a visual guide to guide a user to aim the apparatus at a target authentication device, and a processor; wherein the visual guide is such that when the apparatus aims at a target authentication device following guidance of the visual guide on execution of an authentication process, the content and quality of fidelity of an image of the target authentication device captured by the image capturing device under operational illumination of the light emitting device are sufficient to facilitate verification of authenticity of the target authentication device.

2. An authentication apparatus according to claim 1, wherein the visual guide is such that when the apparatus is aimed at the target authentication device following guidance of the visual guide, the brightness levels on an image of the target authentication device captured by the image capturing device while under operational illumination of the light emitting device are within a predetermined range of brightness levels to facilitate verification of authenticity.

3. An authentication apparatus according to claim 2, wherein the range of predetermined threshold brightness levels is a range within which the quality and/or resolution of the captured image the target authentication device is sufficient to facilitate verification of authenticity.

4. An authentication apparatus according to claim 3, wherein the range of predetermined threshold brightness levels includes an upper threshold brightness level corresponding to a level of maximum brightness at which the captured image of the target authentication device is useable to facilitate verification of authenticity, and/or a lower threshold brightness level corresponding to a level of minimum brightness at which the captured image of the target authentication device is useable to facilitate verification of authenticity.

5. An authentication apparatus according to claim 4, wherein the upper threshold level is a brightness level below brightness saturation, brightness saturation being a phenomenon such that an increase in illumination brightness level at the target authentication device does not bring about an increase in grey scale or brightness level at the captured image.

6. An authentication apparatus according to claim 1, wherein the processor is to process the captured image and to verify authenticity of the target authentication device.

7. An authentication apparatus according to claim 1, wherein the processor is to process the captured image to generate a visible representation of security features embedded in the target authentication device for a user to verify authenticity of the target authentication device.

8. An authentication apparatus according to claim 1, wherein the visual guide includes an alignment device for aligning with a corresponding alignment device on the target authentication device, the visual guide and the light emitting device being arranged such that an axis of light projection corresponding to a line of the brightest illumination by the light emitting device falls outside security features of the target authentication device when the apparatus is aimed at the target authentication device following guidance of the visual guide such that the alignment device of the visual guide and the corresponding alignment device on the target authentication device are aligned.

9. An authentication apparatus according to claim 1, wherein the apparatus includes an associated display device and the processor is to generate the visual guide on the associated display device; wherein the apparatus includes a projector and the processor is to generate the visual guide for projection by the projector.

10. (canceled)

11. An authentication apparatus according to claim 1, wherein the target authentication device comprises an embedded security device having hidden security features, and the processor is to process the captured image of the target authentication device to extract the security features for display.

12. An authentication apparatus according to claim 1, wherein the apparatus includes a memory to store characteristics of a reference authentication device and the processor is to verify authenticity of the target authentication device with reference to the captured image of the target authentication device.

13. An authentication apparatus according to claim 1, wherein the processor is to generate the visual guide upon activation of an authentication process by a user, the authentication process being resident on the apparatus.

14. An authentication apparatus according to claim 1, wherein the processor is to generate the visual guide according to a pre-stored authentication process, the authentication process being apparatus specific and is downloadable through Internet or other telecommunications channels; wherein the processor is to access the authentication process located on a remote computing server to facilitate verification; wherein the light emitting device is a built-in flashlight.

15. (canceled)

16. An authentication apparatus according to claim 1, wherein the apparatus is a mobile device such as a mobile telecommunications device, such as a mobile phone, a smart phone, a tablet computer, or a computer with telecommunications capability, loadable with an authentication process to verify authenticity of the target authentication device.

17. (canceled)

18. An authentication image capturing method for use with an authentication apparatus comprising an image capturing device, a light emitting device to project light for illuminating an object to be captured by the image capturing device, and a processor; wherein the method includes devising a visual guide for guiding a user to aim the apparatus at a target authentication device on execution of an authentication process such that when the apparatus is aimed at the target authentication device following guidance of the visual guide to capture an image of the target authentication device and under operational illumination of the light emitting device, the content and quality of fidelity of the captured image is sufficient to facilitate verification of authenticity of the target authentication device.

19. An authentication image capturing method according to claim 18, wherein the method includes devising the visual guide such that brightness levels on an image of the target authentication device captured by the image capturing device while under operational illumination of the light emitting device are within a predetermined range of brightness levels suitable for verification of authenticity.

20. An authentication image capturing method according to claim 18, wherein the method includes identifying a display portion of a display associated with the authentication apparatus, the display portion being such that an image of the target authentication device corresponding to an image appearing on that display portion when captured such that the brightness levels on the captured image are within the predetermined range of brightness levels will provide sufficient data to facilitate verification of authentication; aiming the apparatus at a sample target authentication device such that an image of the target authentication device will appear on a portion of a display, capturing an image of the sample target authentication device while under illumination of the light emitting device, analyzing brightness levels on the captured image, devising the visual guide on that display portion when the brightness levels on the captured image are within the predetermined range of brightness levels.

21. An authentication image capturing method according to claim 20, wherein the method includes selecting and setting a display portion having a more even distribution of brightness levels on the captured image as the visual guide when there are more than one display portions satisfying requirements.

22. An authentication image capturing method according to claim 20, wherein the method includes selecting a display portion that is outside an axis of light projection which corresponds to a line of the brightest illumination by the light emitting device on the sample target authentication device to devise the visual guide.

23. An authentication image capturing method according to claim 18, wherein the method is in the form of a downloadable software application for running on an authentication apparatus comprising a processor, and the downloadable application is apparatus specific such that a specific application is to be downloaded for a specific apparatus with reference to the model number of the authentication apparatus to run the authentication method.
